(19) United States
(12) Patent Application Publication
(10) Pub. No.: US 2013/0083201 A1
(43) Pub. Date: Apr. 4, 2013

(54) METHODS AND APPARATUS FOR DETERMINING MISALIGNMENT OF FIRST AND SECOND SENSORS

(71) Applicant: Timothy S. Takacs, Parker, TX (US)

(72) Inventor: Timothy S. Takacs, Parker, TX (US)

(73) Assignee: Raytheon Company, Waltham, MA (US)

(21) Appl. No.: 13/251,336

(22) Filed: Oct. 3, 2011

(51) Int. Cl. G06K 9/62; H04N 5/225; G06K 9/36; G06K 9/46; G06K 9/32

(52) U.S. Cl. 348/169; 382/195; 348/E05.024

(57) ABSTRACT

Method and apparatus of the invention determine the spatial and roll mis-alignment of first and second sensors using a common image scene from sensor overlapping Fields of View (FOV). The sensors are dissimilar in one or more of the following respects: Field-Of-View (FOV) size, detector array size, spectral response, gain and level, pixel resolution, dynamic range, and thermal sensitivity.

### STATEMENT REGARDING FEDERALLY SPONSORED RESEARCH

This invention was made with government support under Contract No. W56 HZV-05-C-0724. The government has certain rights in the invention.

### BACKGROUND

As is known in the art, there are a variety of techniques for determining the spatial offset between a pair of ‘like’ images that typically involve the use of image correlation techniques. These techniques become ineffective when the characteristics of the input image pair begin to differ. In particular, image correlation is sensitive to differences in sensitivity, image gain and level, dynamic range, and differences in spectral response. Image correlation techniques also have prohibitively high throughput requirements to handle relatively large azimuth and elevation spatial offsets, image roll, and resolution uncertainty errors.

### SUMMARY

The present invention provides methods and apparatus for determining the spatial and roll mis-alignments of first and second dissimilar sensors using common image scene viewed by each of the sensors. The sensors are dissimilar in one or more of the following respects: Field-Of-View (FOV) size, detector array size, spectral response (any combination of LWIR, MWIR, SWIR, Visible), gain and level applied to the images prior to processing, pixel resolution, image dynamic range, and thermal/contrast sensitivity. In one embodiment, processing of the images accounts for uncertainty in the knowledge of the sensor FOV and pixel resolutions, and handles large spatial offsets, such as up to about forty percent of the smaller of the first and second FOVs.

Exemplary embodiments of the invention employ a multi-mode approach to provide robust scene alignment performance against a variety of rural, urban and other image scenes. The inventive processing performs an assessment of the performance of each processing stage before determining whether the remaining processing stages are required. Exemplary modes include bandpass feature matching, edge feature matching, and image correlation. The bandpass and edge features have invariance to image gain and level, and thermal/contrast sensitivity, as well as efficient scalability to account for differences in sensor pixel resolution.

In one embodiment, the bandpass and edge features are input to a pattern matching module that utilizes a four-dimensional search (e.g., image roll, first sensor to second sensor pixel resolution uncertainty, azimuth spatial offset, elevation spatial offset). The pattern matching processing utilizes feature intensity, feature polarity, and feature position data to determine the best scene match, and matches images given large numbers of uncorrelated image features (due to differences in spectral response). The pattern matching processing determines the highest likelihood spatial offset (along with the corresponding image roll and resolution scale factor), along with a match confidence. The match confidence is a measure of the uniqueness and overall quality of the measured offset. In one embodiment, the match confidence is thresholded to determine if the correct offset has been measured. If the match confidence is less than the threshold, subsequent processing stages are invoked to attempt a scene match and compute a new match confidence. Following completion of the invoked processing stages, the match results, including match confidence, are analyzed and the best match is output. The best match may comprise only the result from one of the three matching modes, or it may combine results from multiple stages if the results are correlated.

In one aspect of the invention, a method comprises processing a first image from a first sensor having a first resolution, a first field of view, and a first spectral band, processing a second image from a second sensor having a second resolution less than or equal to the first resolution, a second spectral band, and a second field of view overlapping with the first field of view to form a common scene, wherein the line of sight for the first and second sensors are different, extracting features in the common scene, matching the extracted features in the common scene, and determining a spatial offset between the first and second sensors based upon the matched features in the common scene.

The method can further include one or more of the following features: generating a confidence value for the spatial offset, using bandpass processing and/or edge mode processing for the step of extracting features, extracting the features further includes identifying minimum and maximum peaks, matching further includes iterative processing over sensor magnification and roll uncertainty, matching further includes using a Hough Transform to generate a score surface, computing an intensity score while computing the Hough transform, matching further includes generating a peak list for computing a match score, performing target correlation for targets in the first and second images, cross checking of output values, handing off a target tracked by the first sensor to a system using the second sensor based upon the spatial offset of the first and second sensors, the first and second sensors are attached to a vehicle, the vehicle is an unmanned vehicle, the first spectral band is selected from the group consisting of LWIR, MWIR, SWIR, and visible, and/or the first and second images are different in one or more of detector array size, gain, dynamic range, and/or thermal/contrast sensitivity.

In another aspect of the invention, an article comprises a computer readable medium including non-transitory stored instructions that enable a machine to perform: processing a first image from a first sensor having a first resolution, a first field of view, and a first spectral band, processing a second image from a second sensor having a second resolution less than or equal to the first resolution, a second spectral band, and a second field of view overlapping with the first field of view to form a common scene, wherein the line of sight for the first and second sensors are different, extracting features in the common scene, matching the extracted features in the common scene, and determining a spatial offset between the first and second sensors based upon the matched features in the common scene.

The article can further include instructions for one or more of the following features: generating a confidence value for the spatial offset, using bandpass processing and/or edge mode processing for the step of extracting features, extracting the features further includes identifying minimum and maximum peaks, matching further includes iterative processing over sensor magnification and roll uncertainty, matching further includes using a Hough Transform to generate a score surface, computing an intensity score from the Hough transform, matching further includes generating a peak list for computing a match score, performing target correlation for targets in the first and second images, cross checking of output values, handing off a target tracked by the first sensor to a system using the second sensor based upon the spatial offset of the first and second sensors, the first and second sensors are attached to a vehicle, the vehicle is an unmanned vehicle, the first spectral band is selected from the group consisting of LWIR, MWIR, SWIR, and visible, and/or the first and second images are different in one or more of detector array size, gain, dynamic range, and/or thermal/contrast sensitivity.

In a further aspect of the invention, a system comprises a first sensor to generate a first image, a second sensor to generate a second image, the first and second sensors having different resolutions, fields of view, and spectral bands, and a processing means for processing the first and second images to determine a spatial offset between the first and second sensors.

### BRIEF DESCRIPTION OF THE DRAWINGS

The foregoing features of this invention, as well as the invention itself, may be more fully understood from the following description of the drawings in which:

FIG. 1 is a block diagram of an exemplary system to process information from multiple sensors and determine sensor misalignment;

FIG. 2A is a first image from a first sensor and FIG. 2B is a second image from a second sensor, the first and second sensors having different resolutions, FOVs, and spectral bands;

FIG. 3 is a flow diagram to implement feature extraction;

FIG. 3A is a flow diagram showing further detail of bandpass processing for the feature extraction of FIG. 3;

FIG. 3B is a flow diagram showing further detail of edge mode processing for the feature extraction of FIG. 3;

FIG. 4A shows raw data for a first image and FIG. 4B shows the first image after bandpass filtering;

FIG. 4C shows raw data of a second image and FIG. 4D shows the second image after bandpass filtering;

FIG. 5A shows a third raw image, FIG. 5B shows the image of FIG. 5A after an overlay of extracted edge features, and FIG. 5C shows a lower resolution image of a common scene with an overlay of extracted edge features;

FIG. 6 is a flow diagram showing feature matching processing;

FIG. 6A is a first image from a first sensor, FIG. 6B is a second image from a second sensor having a lower resolution, and FIG. 6C shows azimuth and elevation spatial offsets of a target relative to the second image center;

FIG. 6D is a flow diagram showing feature matching processing;

FIG. 6E is a flow diagram showing further detail of the feature matching of FIG. 6D;

FIG. 7 is a flow diagram showing target correlation processing;

FIG. 7A is a first image having a high signal-to-clutter ratio target, FIG. 7B shows a target image chip created from the first image, and FIG. 7C shows a resultant correlation surface;

FIG. 8A is a second image having a moderate signal-to-clutter ratio target, FIG. 8B is a target image chip, and FIG. 8C shows a correlation surface;

FIG. 9 is a flow diagram showing output computation;

FIG. 9A is a flow diagram showing further detail for the cross correlation step in FIG. 9; and

FIG. 10 shows an exemplary computer that can perform processing in accordance with exemplary embodiments of the invention.

### DETAILED DESCRIPTION

In general, exemplary embodiments of the present invention determine the spatial and roll mis-alignment of first and second sensors using the common image scene viewed by the sensors. The sensors are dissimilar in one or more of the following respects: Field-Of-View (FOV) size, detector array size, spectral response (any combination of MWIR, LWIR, SWIR, Visible), gain and level, pixel resolution, dynamic range, and thermal/contrast sensitivity.

It is desirable to determine the amount of misalignment between sensors for a number of applications. For example, the amount of sensor misalignment can be used to allow automated handoff of targets acquired and tracked using a high-resolution sensor to a lower resolution sensor. In one embodiment, a lower resolution sensor may be used to engage a target after acquisition by a higher resolution sensor. In addition, unmanned vehicles may utilize a number of sensors having differing characteristics. Other embodiments include automatic boresighting of sensors within a common sensor package without the aid of an active boresight source component.

Exemplary embodiments of the invention attempt to match common scene content in an image pair acquired from different sensors, which produce differing images when viewing the same scene. By processing the images, the system can handle relatively large offsets and uncertainties in sensor parameters by focusing on certain features within the scene.

While exemplary embodiments of the invention are shown and described in conjunction with certain types of sensors and wavelengths, it is understood that embodiments of the invention are applicable to multi-sensor systems in general in which it is desirable to use common scene information from multiple sensors.

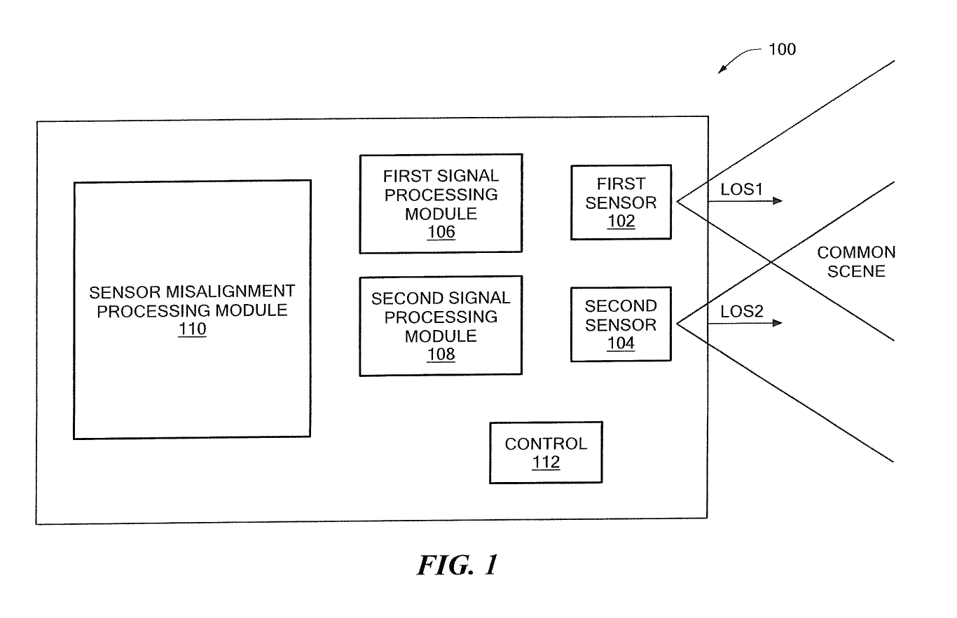

FIG. 1 shows an exemplary sensor system 100 having a first sensor 102 and a second sensor 104 with a common scene region in which the FOVs for the first and second sensors overlap. The first sensor 102 has a first line of sight LOS1 and the second sensor 104 has a second line of sight LOS2 that is different from the first line of sight LOS1. The first and second sensors 102, 104 can differ in one or more of Field-Of-View (FOV) size, detector array size, spectral response (any combination of MWIR, LWIR, SWIR, Visible), gain and level, pixel resolution, dynamic range, and thermal/contrast sensitivity.

A first signal processing module 106 receives information from the first sensor 102 and a second signal processing module 108 receives information from the second sensor 104. A sensor misalignment module 110 receives information from the first and second signal processing modules 106, 108 to determine sensor misalignment information, as described in detail below. In one embodiment, the sensor misalignment module 110 determines a difference in LOS pointing angles for the first and second sensors 102, 104, such as azimuth and elevation information, roll angle difference, and measurement confidence. A control module 112 can include a processor to control the overall operation of the sensor system.

The first and second sensors 102, 104 have a number of characteristics that can differ. The values for the various characteristics can be known or unknown. Exemplary characteristics include FOV, which can be defined in azimuth and elevation in degrees, for example. While nominal values may be known, unit-to-unit and temperature variability may be unknown. The detector array size and nominal pixel resolution are known while the relative roll angle may be unknown. As used herein, roll angle refers to the two-dimensional image produced by each of the two sensors including a roll component relative to the local-level of the image scene being viewed. In other words, with zero roll a level or flat terrain feature will also be level or flat within the displayed image. If the sensor has a roll component relative to local-level, the level and/or flat terrain feature will have a slope within the displayed image. Exemplary embodiments of the invention account for the differences in roll attitude (i.e. relative roll) between the two sensors. The detector type (e.g., MWIR, LWIR, SWIR, etc.,) is known while the detector sensitivity may be unknown. The gain and level applied in the signal processing may also be unknown. The sensors are typically close in physical location since they have an overlapping FOV and can have known locations. In one embodiment, the physical location of the sensors is less than one meter apart in any dimension. In exemplary embodiments, digital images from the sensors are correlated in time for actively slewing sensors.

It is understood that Short-wavelength infrared (SWIR) has a wavelength of 1.4-3 μm, Mid-wavelength infrared (MWIR, also called intermediate infrared (IIR)) has a wavelength of 3-8 μm, Long-wavelength infrared (LWIR) has a wavelength of 8-15 μm, which include Forward-looking infrared (FLIR), and Far infrared (FIR) has a wavelength of 15-1,000 μm.

It is further understood that sensor misalignment can be determined for any practical type of imaging sensor which is responsive within the visible to infrared waveband.

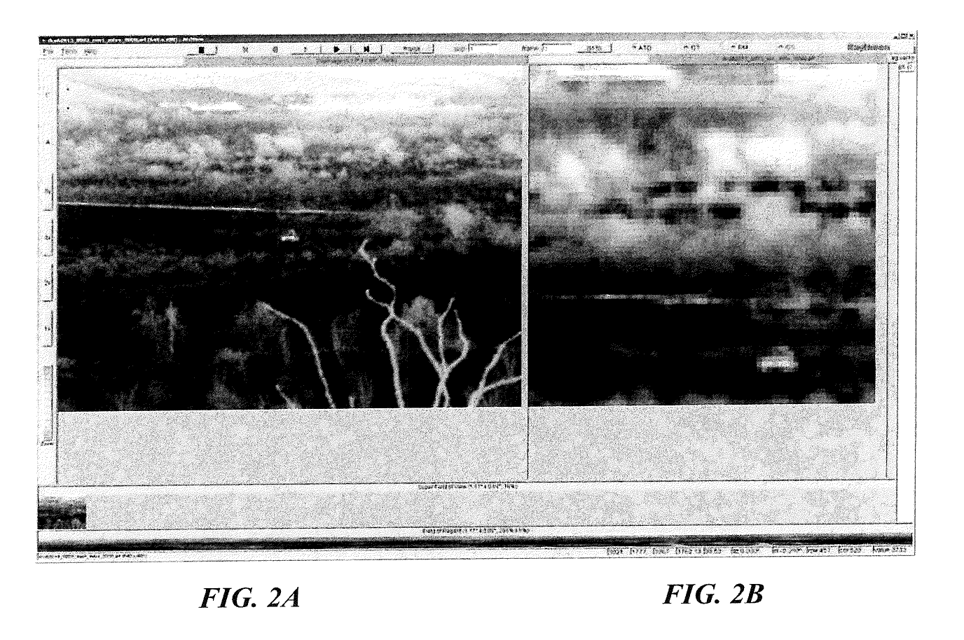

FIG. 2A shows a first image 200a from a first sensor and FIG. 2B shows a second image 200b from a second sensor. The first sensor is a midwave infrared type sensor and the second sensor is a longwave infrared type sensor. An object of interest or target is shown in a box 202a, b in the respective first and second images 200a, b.

As can be seen, the first image 200a has a higher resolution than the second image 200b. As described more fully below, the images are processed to determine the azimuth and elevation spatial offsets between the first and second images 200a,b and generate a confidence value for a correctly determined spatial offset between the image pair. As used herein, spatial offset refers to the difference in the Line-Of-Sight pointing angles (azimuth and elevation) of the two sensors, including the difference in roll attitude of the sensors with respect to local-level. In one embodiment, the measured spatial offset data is used to automatically compute target acquisition gates for a system using the lower resolution second sensor based on the position of target track gates reported from the higher resolution first sensor. In addition to differences in resolution between the first and second images 200a, b, the Field Of View (FOV) size and scene coverage, LOS, and magnification between the two images may also be different.

To successfully measure the spatial offset, the images are processed to account for differences between the first and second images 200a,b. For example, the first image is MWIR and the second image is LWIR so that phenomenology differences between the two spectral bands results in differences in the background and target signatures due to the thermal properties of the materials present in the scene. In addition, the first and second images have different FOV size, digital image size, pixel resolution, and temperature sensitivity. Further, the first and second sensors are not coaxial and there may be a roll angle component. It is understood that the first and second images 200a,b are time-correlated, i.e., they are captured closely together in time.

In an exemplary embodiment, processing of the images to determine the spatial offset can vary depending upon the characteristics of the images. In one embodiment, measurement techniques include feature matching based on bandpass contrast features, feature matching based on edge-based features, and target correlation. The bandpass feature matching mode can be the primary offset measurement technique for each image pair. In one embodiment, the other techniques are only utilized if the bandpass feature mode is unsuccessful in producing a sufficient confidence measurement.

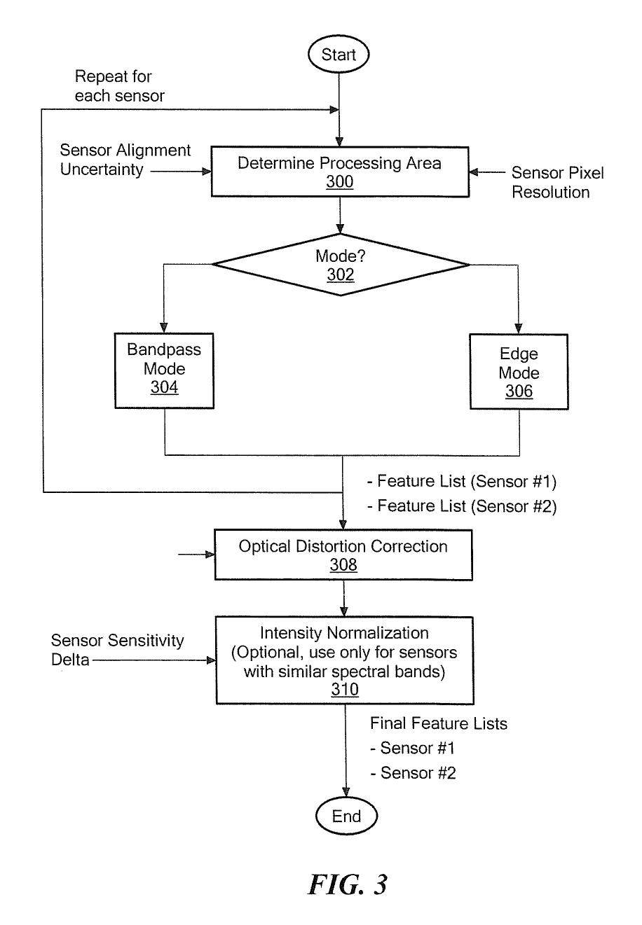

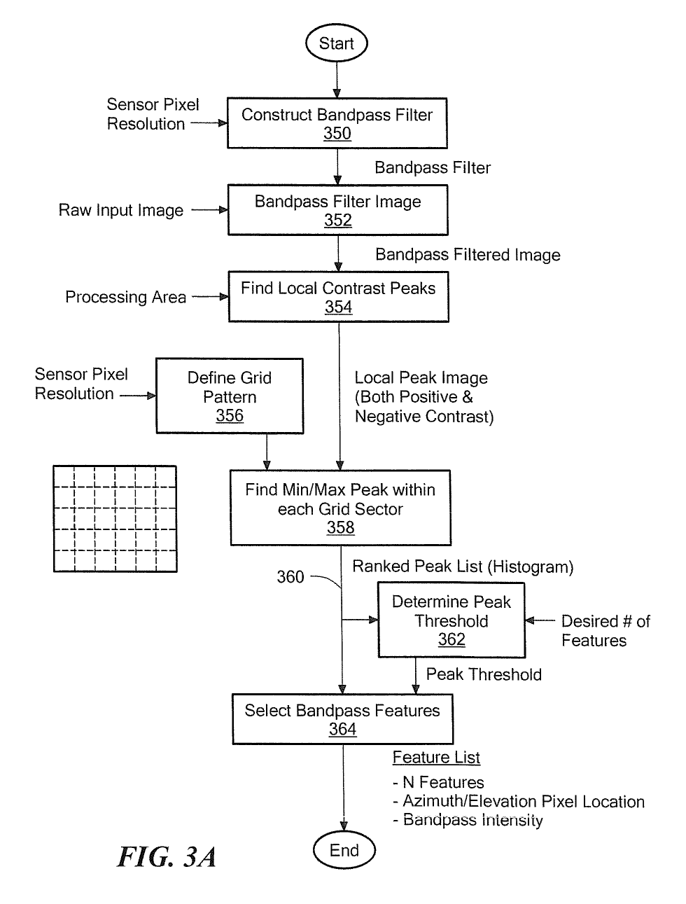

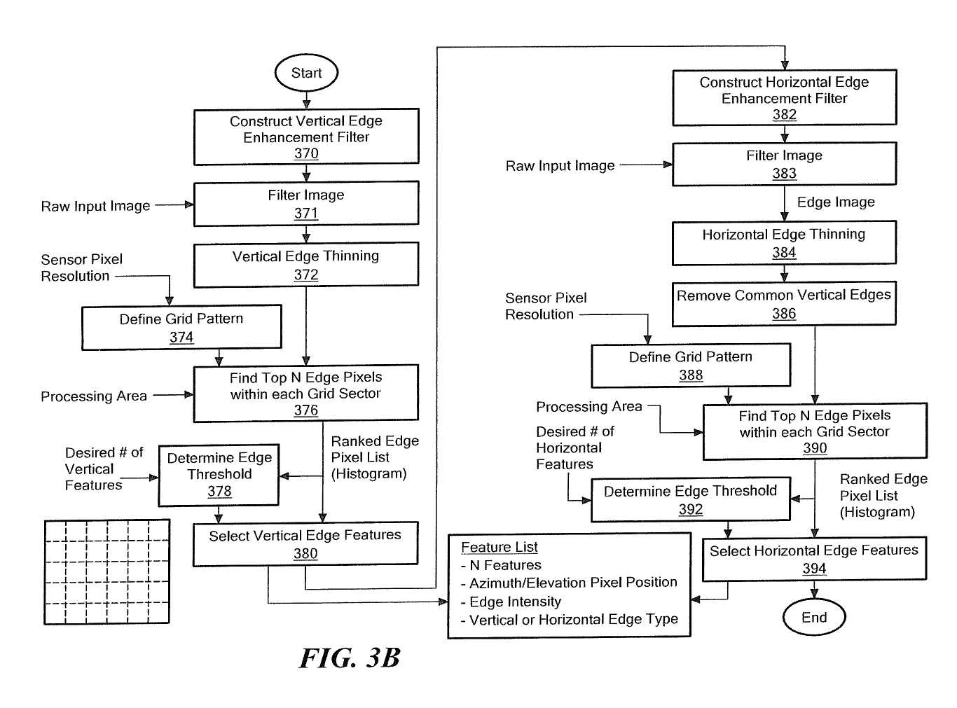

FIG. 3 shows exemplary processing of the first and second images for feature extraction. The images are processed one at a time as they are received. In step 300, a processing area for an image is determined. The processing area can comprise the entire image or a portion of the image. In step 302, it is determined whether bandpass mode processing 304 is used or edge mode processing 306 is used. The bandpass mode and edge mode processing take into account the sensor characteristics noted above. In step 308, distortion in the images can be corrected. In optional step 310, intensity normalization for the image data is performed.

FIG. 3A shows further detail for the bandpass processing 304 of FIG. 3. In step 350, a bandpass filter is based upon the sensor pixel resolution. To construct the bandpass filter, the notional 2-dimensional bandpass filter has a fixed angular size. This is converted to a spatial filter with size X and Y pixels, with X and Y computed based on each sensors unique pixel resolution. The resultant filters, while different in pixel size proportional to the difference in pixel resolution, produce the same bandpass response in angular space. In step 352, bandpass filtering of the image is performed to identify local contrast peaks in step 354. In step 356, a grid pattern is defined based upon the sensor resolution. In step 358, the minimum and maximum contrast peaks for each grid sector in the grid pattern are extracted. In step 360, the extracted contrast peaks are ranked and in step 362 the peak threshold is determined to select a desired number of features in the image. In step 364, the desired number of features is selected with azimuth/elevation pixel locations and bandpass intensity information.

FIG. 3B shows further detail for edge mode processing 306 in FIG. 3. In step 370, a vertical edge enhancement filter is constructed. Edge enhancement is a well-known image processing technique for enhancing the edge contrast to improve the perceived sharpness of an image. The edge enhancement filter identifies edge boundaries, such as between target and background, and increases the image contrast. In step 371, the raw image data is filtered and in step 372 vertical edge thinning is performed. In step 374, a grid pattern for the image is generated and in step 376 the top N edge pixels within each grid sector are identified and ranked. In an exemplary embodiment, “top” refers to the highest ranked, i.e. highest contrast, edge pixels, where N defines how many pixels. In step 378, an edge threshold is chosen to select a desired number of the vertical features in step 380. Features below the threshold are not selected so that a threshold can be chosen to select the top one hundred features, for example.

In step 382, a horizontal edge enhancement filter is constructed to filter raw image data in step 383. Horizontal edge thinning is performed in step 384 and common vertical edges are removed in step 386. In step 388, a grid pattern is defined and in step 390 the top N edge pixels in each grid sector are identified. In step 392, an edge threshold is determined to select a desired number of horizontal features in step 394. The selected features have azimuth/elevation pixel positions, edge intensity values, and vertical or horizontal edge identification.

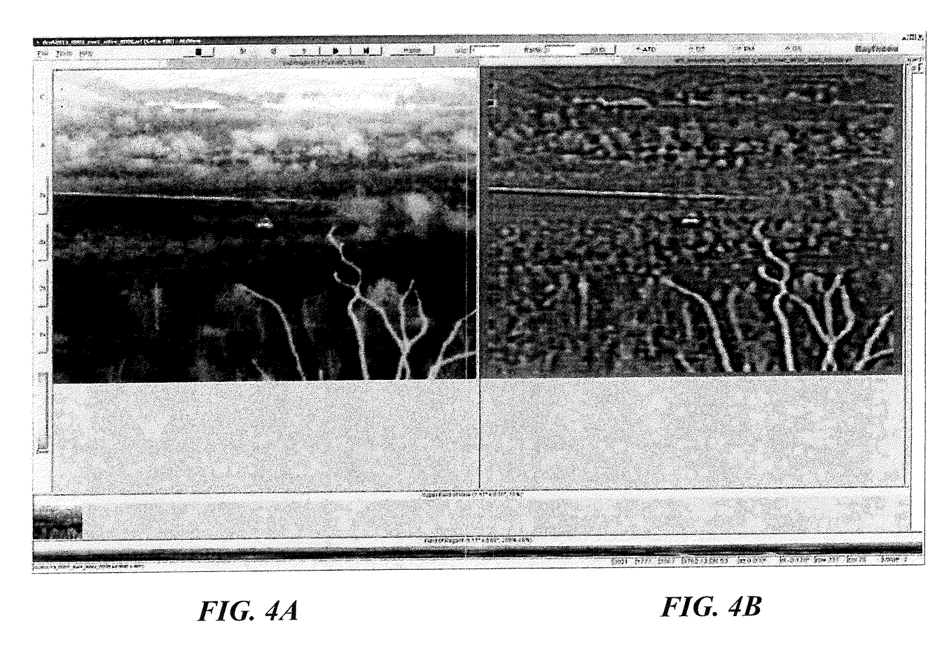

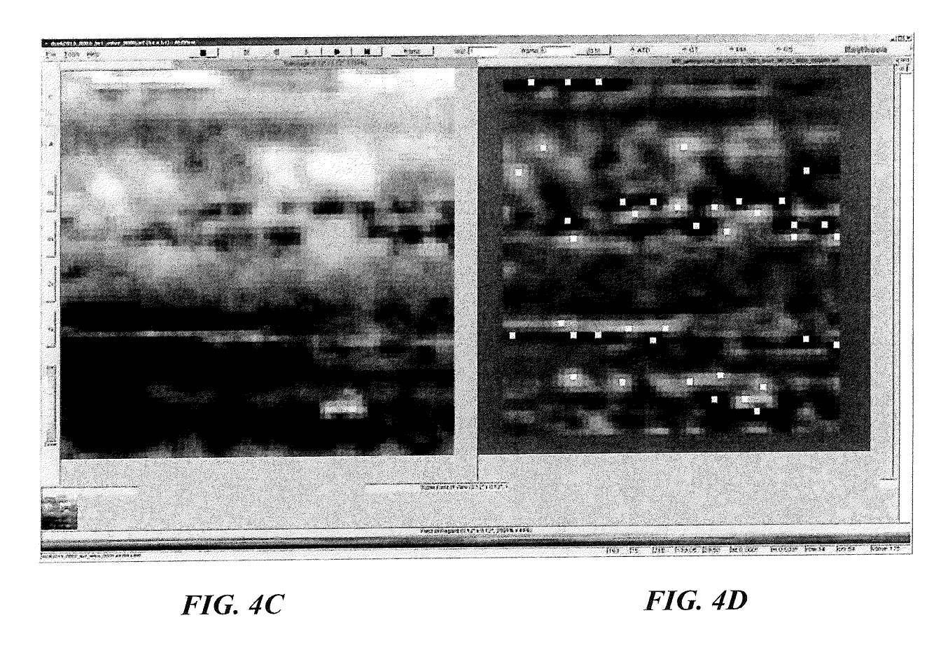

FIG. 4A shows first a raw image having a first resolution and FIG. 4B shows the result of bandpass filtering the raw image. The bandpass filtered image can have any practical number of features, which are indicated by bright dots overlaid onto the image.

FIG. 4C shows a second raw image having a second resolution less than the first resolution of the first raw image of FIG. 4B. FIG. 4D shows the result of bandpass filtering the second raw image of FIG. 4C. The bright dots indicating the bandpass features are again overlaid onto the image. The images of FIGS. 4A and 4C have a common scene from overlapping FOVs.

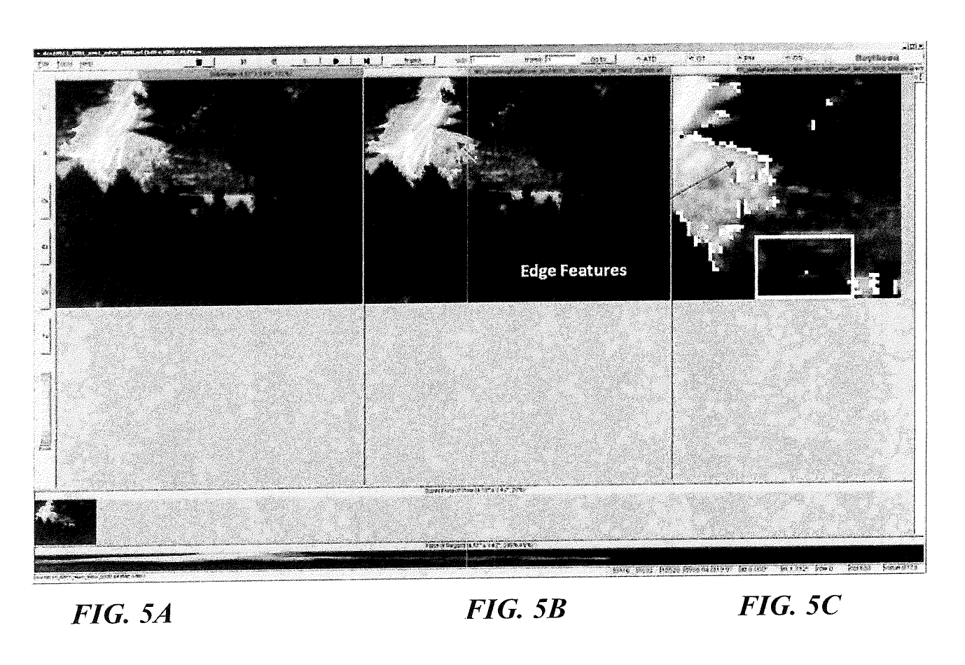

FIG. 5A shows a raw image, FIG. 5B shows the image after an overlay of the extracted edge features for the image, and FIG. 5C shows a lower resolution for a common scene in the image with an overlay of the extracted edge features. The image in FIG. 5A is from a first sensor and the image in FIG. 5C is generated from a second sensor have lower resolution than the first sensor. The edge features are indicated by the maximum intensity white and minimum intensity black pixels located along areas of strong edge strength, both horizontally and vertically, within the image. In this example, the maximum intensity white pixels in FIG. 5B image overlay indicate edge features that matched with edge features in the image overlay of FIG. 5C. The minimum intensity black pixels are edge features which did not match an edge feature within the corresponding images. Since the first sensor Field-Of-View (FOV) is significantly larger than the second sensor FOV, the majority of unmatched edge features are those located in areas which do not overlap the second image. Most of the edge features in the second sensor image match an edge feature in the first sensor image. The white rectangular box in FIG. 5C image indicates the position of the target based on the angular offset determined from the extracted edge features.

As described above, feature matching processing is performed once both the first image and second image feature lists are created. In one particular embodiment, feature matching processing utilizes a modified Hough Transform pattern matching technique to compare the feature lists for the first and second images and determine the most likely spatial offset position. As part of the comparison process, feature matching processing varies the first and second sensor resolution ratio, and the sensor roll angle to account for uncertainty in the knowledge of those values. The highest likelihood spatial alignment match and corresponding match confidence is computed for each combination of sensor resolution ratio and roll, and the highest overall score is chosen as the ‘best’ spatial alignment match, where ‘best’ refers to the highest overall score from all combinations of sensor resolution ratio and roll that are evaluated.

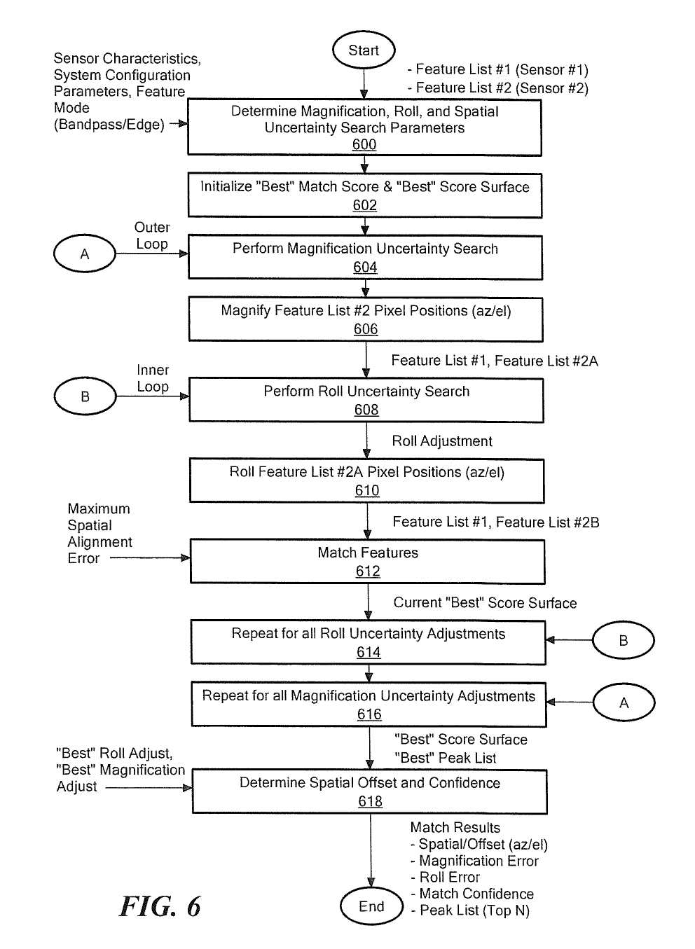

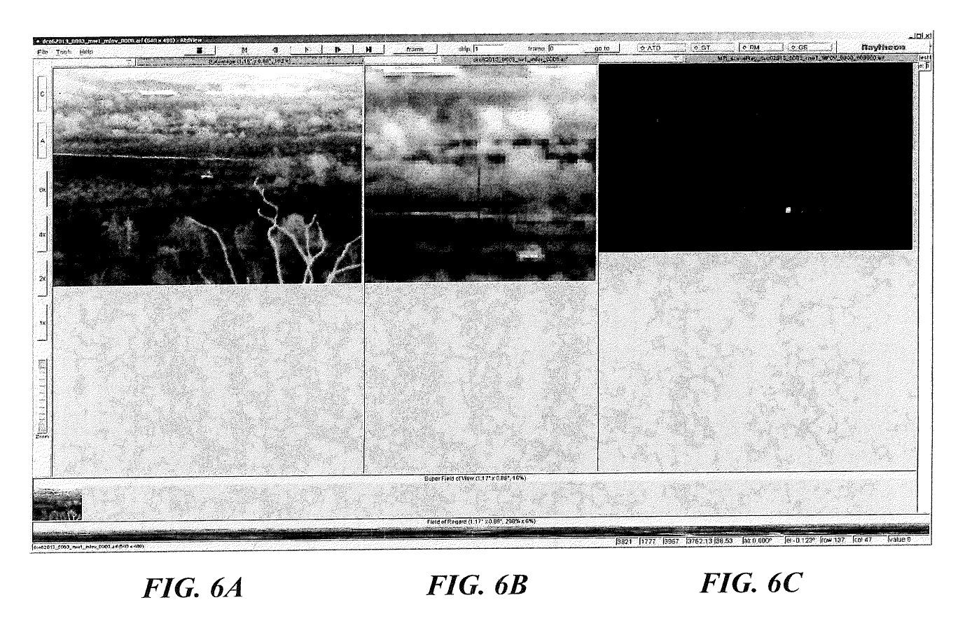

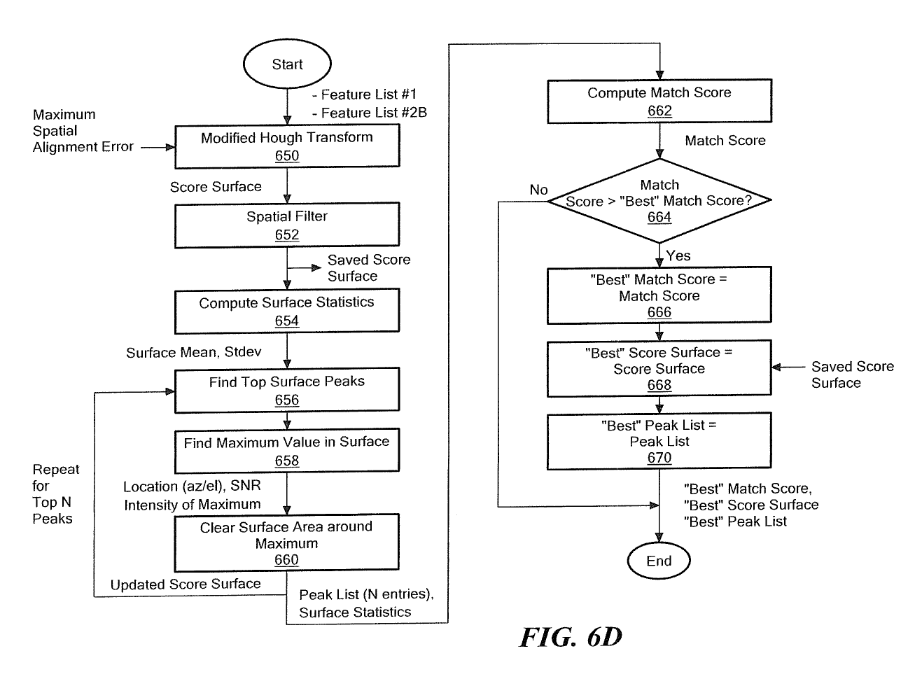

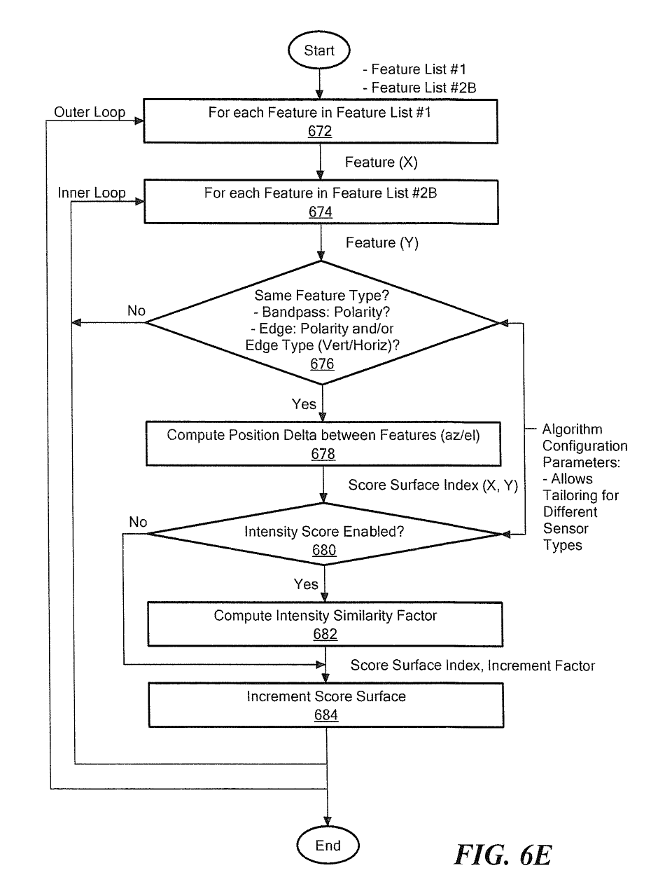

FIG. 6 shows an exemplary sequence of steps for implementing feature matching processing in accordance with exemplary embodiments of the invention. It is understood that feature matching utilizes the previously determined feature lists for the images from the first and second sensors. In step 600, the system determines the magnification, roll, and spatial uncertainty search parameters from the sensor characteristics, configuration parameters, and mode, e.g., bandpass or edge. For example, the maximum alignment offset in az/el pixels in the feature search space is based upon the expected mechanical misalignment of the first and second sensors and their respective pixel resolutions.

In step 602, the ‘best’ match score and the ‘best’ score surface values are initialized. To determine the ‘best’ values, i.e. highest scoring, the “best” score surface is the score surface corresponding to the “best” match score, an outer loop iterates on magnification values, e.g., the sensor resolution ratio, and an inner loop iterates on roll angle values.

In step 604, the outer loop begins over a range of first to second sensor pixel resolution ratios, e.g., magnifications. In step 606, for each peak in the original peak list for say, the second image, the system computes new az/el pixel location based on this iteration's resolution ratio and stores results in a temporary file, e.g., Temp Peak List 1. In step 608, the inner loop begins over a range of first to second sensor roll uncertainty. For each peak in Temp Peak List 1, the system computes new az/el pixel location based on this iteration's roll value and stores the results in temporary file Temp Peak List 2. In step 612, a transform, such as a Hough Transform is used on the first image peak list and Temp Peak List 2, to match features. In one embodiment, the system applies a spatial filter to the match surface, finds the maximum value in the match surface, and saves its location, SNR, and local amplitude. If the local amplitude of first peak is greater than the ‘best’ local amplitude so far, then the ‘best’ local amplitude is set to the first peak local amplitude, and so on. Processing continues in step 614 until the roll uncertainty adjustments are complete and in step 616 until the magnification uncertainty adjustments are complete. When the outer loop for the magnification is complete, the ‘best’ score surface and the ‘best’ peak list can be output. In step 618, the system determines the spatial offset between the first and second sensors generating the images and a confidence value. The match results include spatial offset (az/el), magnification error, roll error, match confidence, and peak list.

FIG. 6A shows a first image from a first sensor and FIG. 6B shows a second image from a second sensor having a lower resolution than the first sensor. A target T can be seen in the center of the first image and the bottom right corner of the second image. FIG. 6C shows the azimuth and elevation spatial offsets of the target relative to the second image center. The match surface generated from processing of the first image and peak lists for the second image is shown in the right-most portion of the figure. The brightest dot, located near the bottom center of the match surface represents the maximum match score. The arrows indicate the measured mis-alignment of the first and second images. Note that the arrows in the second image (FIG. 6B) and the arrows in the match surface (FIG. 6C) have a different scale (due to differences in pixel resolution), so while the offset directions are the same, the magnitudes differ. The differences in resolution between the first and second sensors are accounted for when computing the offset values reported to the system. The second brightest dot in the match surface is also indicated. The relative magnitudes of the two brightest dots (i.e. scores) in the match surface are used to compute a Signal-To-Noise (SNR) metric, which in turn is used in the computation of the overall match confidence metric.

FIG. 6D shows further detail for the match feature processing 612 of FIG. 6. In step 650, the maximum spatial alignment error is used in a modified Hough transform to generate a score surface. Hough transforms are well known in the image processing field. A Hough transform is a feature extraction technique used in image processing to find imperfect instances of objects within a certain class of shapes by a voting procedure. This voting procedure is carried out in a parameter space from which object candidates are obtained as local maxima in accumulator space for computing the Hough transform. In exemplary embodiments of the invention, the Hough transform is used to match the extracted feature patterns from the two sensors, with the accumulator maxima indicating the most likely spatial offset. In step 652, a spatial filter is used to filter the score surface and in step 654 statistics are computed for the match surface, such as surface mean and standard deviations. For the top N peaks, steps 656-660 are performed in a loop. Step 656 provides a loop controller. In step 658, the maximum value in the surface is identified with an associated location in az/el, SNR, and intensity maximum. In step 660, the surface area around the maximum is cleared to update the score surface and allow the next highest peak to be identified.

In step 662, after the loop is complete, the match score is computed. In step 664, it is determined whether the computed match score is greater than the currently stored ‘best’ match score. If so, in step 666, the ‘best’ match score is updated to contain the new best score. In step 668, the best score surface is updated to contain the new best score surface and in step 670, the best peak list is updated to contain the new best peak list.

FIG. 6E shows further details for the Hough transform step 650 of FIG. 6D. In step 672, an outer loop is initiated for each feature in the feature list for the first image. In step 674, an inner loop is initiated on the feature list for the second image. Feature List 213 refers to the feature list from the second image modified for this iterations magnification and roll adjustments (from FIG. 6.)

In step 676, it is determined whether the two features of the present iteration are the same type. For example, the bandpass polarity and the edge polarity and/or type (vertical or horizontal) are examined to see if they are the same. Configuration parameters can be taken into account to allow for tailoring of different sensor types. For example, if the two sensors are both LWIR, then it can be expected that the scene features would have the same polarity, and it would be beneficial to only compare features with the same polarity. Conversely, if one sensor was LWIR and the second was visible, then it would not be expected that signal polarities would match given the significant difference in spectral bands; it would therefore be best to ignore feature polarity when matching features. For edge feature matching, the algorithm purposely tries to create an equal number of horizontal and vertical features, so the edge type comparison should always be used.

If the features are not the same type, the score surface increment in step 684 is bypassed and loop processing continues. If the features are the same type, in step 678 the position delta between the features is computed in az/el. A score surface index has a an x,y identifier. In step 680, it is determined whether to enable the intensity score. If not, the score surface index is incremented in step 684 and loop processing continues. If so, an intensity similarity factor is computed from the same feature types in step 682. The score surface index is incremented in step 684 and loop processing continues. Use of the Intensity Score is similar to the logic employed for step 676. Like sensors->use it, otherwise don't use it.

In the event that the primary offset measurement processing fails to find a high confidence scene match, a secondary method can be used to attempt to find the target in the first image within the second image frame using image correlation techniques. Due to differences in sensor information, such as MWIR and LWIR phenomenology, differences in image gain and level, and target position uncertainty, the secondary approach discussed below may perform only under a limited set of scene and target conditions, such as good target Signal-to-Clutter ratios and full target containment within the second image.

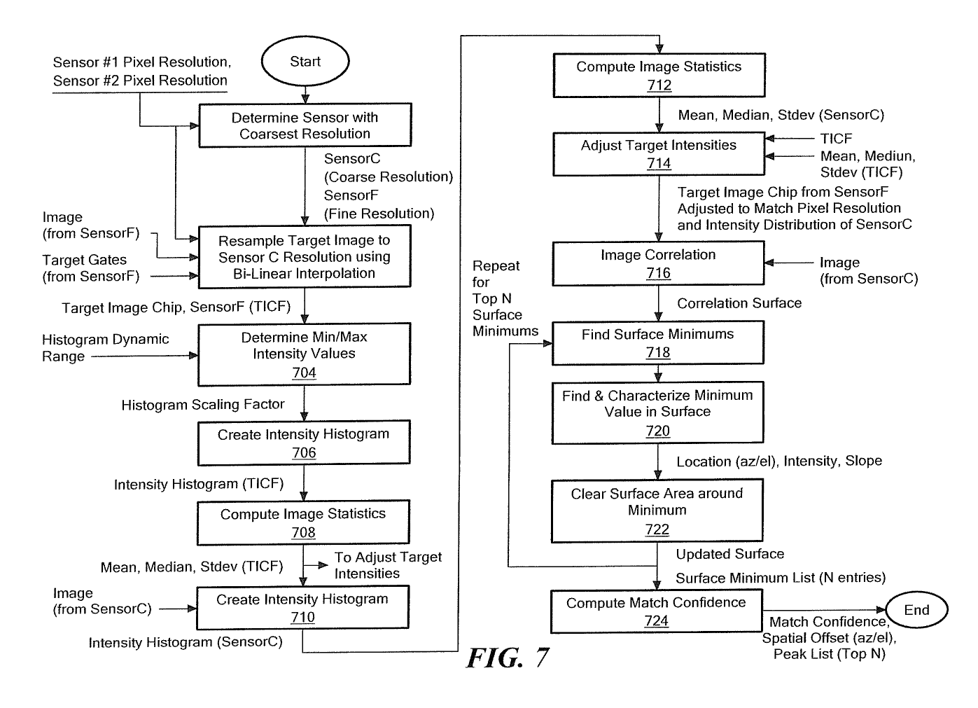

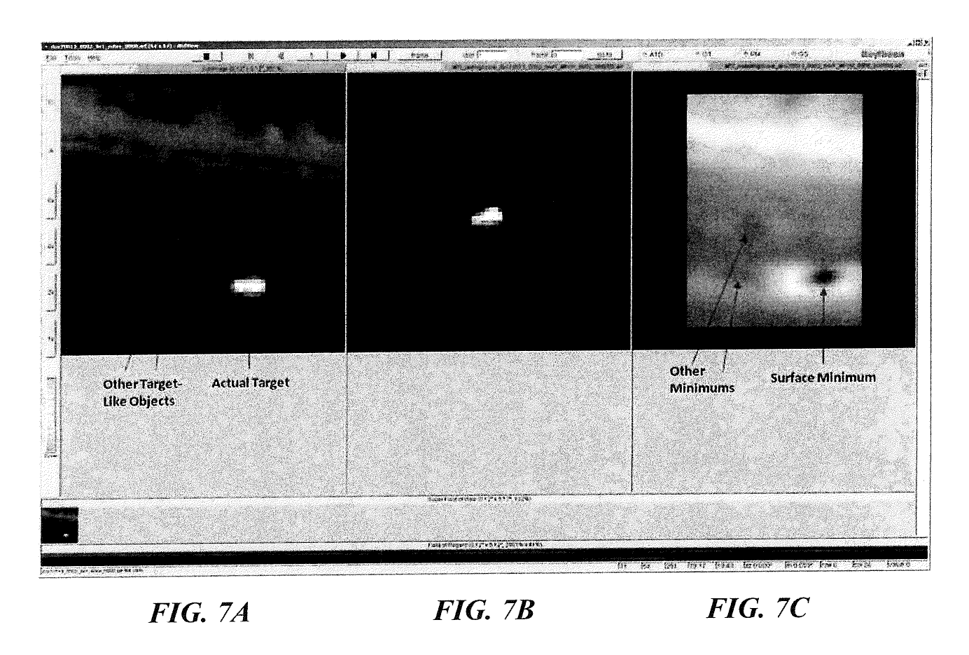

FIG. 7 shows an exemplary sequence of steps for implementing target correlation processing in accordance with exemplary embodiments of the invention. In step 700, it is determined which sensor has a more coarse resolution. For this embodiment, sensor C is considered coarse and sensor F is considered fine. In step 702, the image from sensor F is resampled to sensor C resolution using bi-linear interpolation, for example, to generate a target image chip, which can be indicated as Sensor F (TICF). Target gates from the sensor F image are used for the resampling.

In step 704, the minimum and maximum intensity values are determined. In one embodiment, an intensity histogram is generated in step 706. In step 708, image statistics are computed, such as mean, median, and standard deviation for the TICF.

In step 710, an intensity histogram is created from the Sensor C image. In step 712, image statistics for the sensor C image are computed, such as mean, median, and standard deviation for the Sensor C image. In step 714, the target intensities of TICF are adjusted to match the intensity distribution of the Sensor C image.

In step 716, image correlation is performed between the adjusted TICF and the Sensor C image to generate a correlation surface. In step 718, a loop is initiated where the top N surface minimums are identified. In step 720, for the given surface minimum iteration, the minimum value in the surface is identified and characterized such that the minimum value in the surface has a location in az/el, intensity, and slope. In step 722, the surface area around the minimum is cleared to update the surface allowing detection of the next lowest minimum. In step 724, a match confidence value is computed.

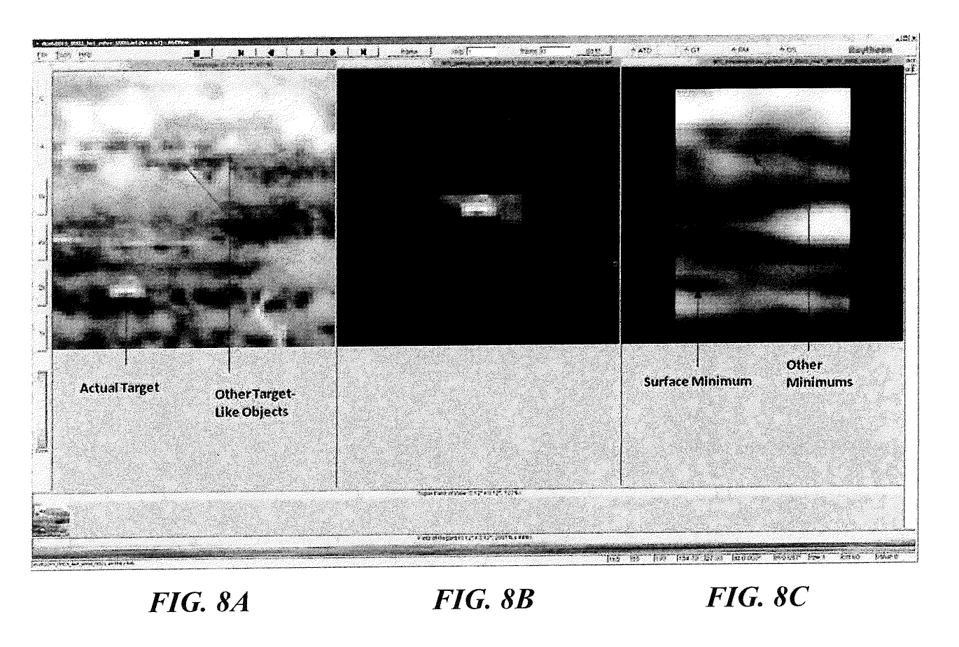

FIGS. 7A-C and FIGS. 8A-C illustrate two examples of target correlation processing in accordance with exemplary embodiments of the invention. FIGS. 7A-C show results for a high Signal-to-Clutter target. FIG. 7A shows the target in the lower right hand corner of the lower resolution sensor. FIG. 7B shows the Target Image Chip created from the higher resolution image. FIG. 7C shows the resultant correlation surface. In this example, the correlation surface has an easily identifiable minimum at the position corresponding to the target position in the lower resolution image in FIG. 7A. The other local minimums in the surface are of a much higher magnitude than the minimum associated with the actual target. The wide separation in the magnitude of the surface minimums results in a high confidence and accurate measurement of the target position within the lower resolution image of FIG. 7A.

FIG. 8A-C illustrate target correlation processing for a moderate-to-low Signal-to-Clutter (SCR) target. In this example, while in FIG. 8A the target is somewhat distinguishable from the background clutter, there are several similar looking clutter objects in the scene. The resultant correlation surface in FIG. 8C contains numerous local minimums, each of similar magnitude. The difference in magnitude between the surface minimum corresponding to the actual target position and the surface minimums corresponding to the other target-like clutter objects is small, resulting in a low confidence or potentially incorrect measure of the targets position within the lower resolution image. The ability to distinguish between the true target and other target-like clutter objects in the scene is made more difficult due to: a) the difference in spectral bands between the higher resolution MWIR image and the lower resolution LWIR sensors, and b) the difference in the intensity distributions of the two images due to differences in gain and level. The difference in spectral bands results in differences in the background and target signatures between the two images. The differences range from minor to significant, dependent on the time of day, the sensor viewing perspective, and the thermal properties of the materials present in the scene.

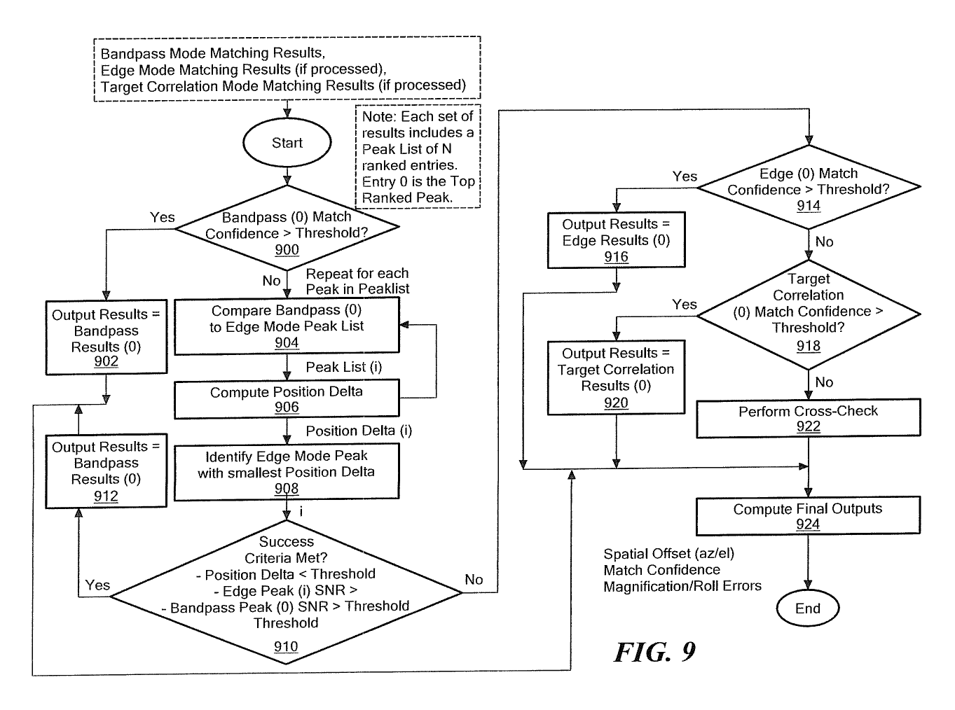

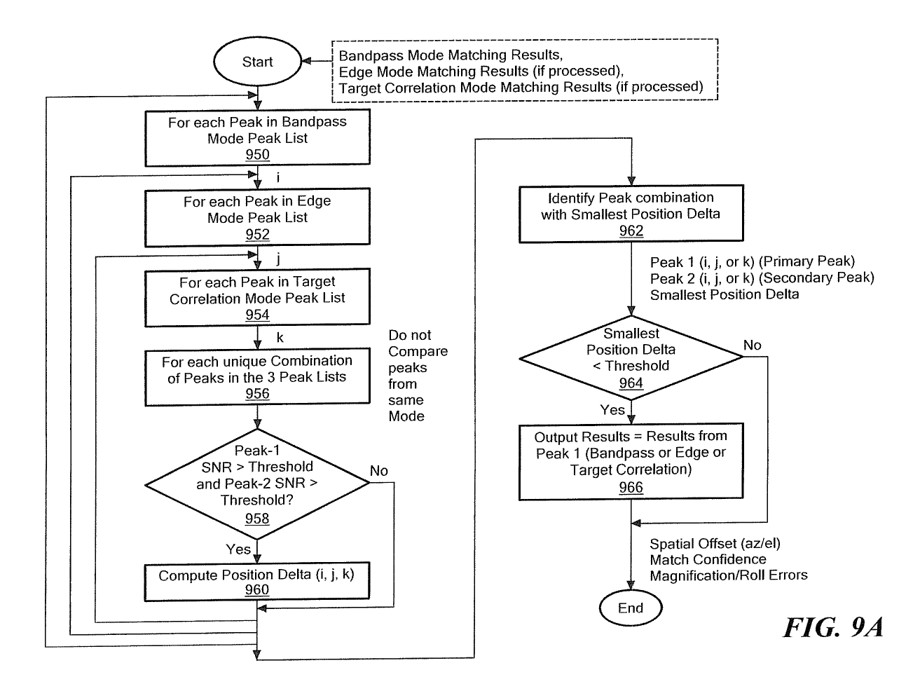

FIG. 9 shows an exemplary sequence of steps for computing outputs for the first and second dissimilar sensor image processing. As described above, in one embodiment, bandpass mode processing occurs and edge mode processing and/or target correlation mode processing occurs if the bandpass processing does not meet certain criteria. As also noted above, the results for each mode include a peak list of N ranked entries. For the below description, entry 0 is considered the top ranked peak.

In step 900, it is determined whether bandpass(0), i.e., the top ranked peak, has a match confidence greater than a selected threshold. If so, the bandpass(0) result is output in step 902. If not, in step 904, a loop is initiated to compare bandpass peak(0) to the edge mode peaks. For each bandpass/edge peak iteration, a position delta is computed in step 906. The position delta represents the sum of the differences in az/el position of the bandpass and edge peak being processed. i.e., are they indicating the same or similar spatial offset? After the loop completes, the edge mode peak with the smallest position delta is identified in step 908. In step 910, it is determined whether success criteria are met, such as whether the position delta is less than a given threshold, whether the edge peak SNR ratio is greater than a second threshold, and/or whether the bandpass peak(0) SNR is greater than a selected threshold. If so, in step 912, the bandpass(0) result is output. If not, in step 914, it is determined whether the edge(0) match confidence value is greater than a selected threshold. If so, in step 916, the edge(0) result is output. If not, in step 918 it is determined whether target correlation (0) match confidence is greater than a given threshold. If so, the target correlation(0) result is output in step 920. If not, in step 922 a cross check is performed and in step 924 the final outputs are output, such as spatial offset in az/el, match confidence, and magnification/roll errors.

FIG. 9A shows further detail for the cross check step 922 of FIG. 9. It is understood that peaks are not compared from the same mode. Processing is performed in a series of nested loops. In step 950, the first loop is initiated that runs for each peak in the bandpass mode peak list. In step 952, the second loop is initiated for each peak in the edge mode peak list. In step 954, the third loop is initiated for each peak in the target correlation mode peak list. In step 956, each unique combination of the peaks in the three peak lists is generated and in step 958, it is determined whether peak-1 SNR is greater than a first threshold and whether peak-2 SNR is greater than a second threshold, which can be the same as the first threshold. If so, in step 960, a position delta (i,j,k) is computed. This process is repeated for all 3 nested loops. In step 962, the peak combination with the smallest position delta is identified. In step 964, it is determined whether the smallest position delta is less than a selected threshold. If so, the results from peak 1 (bandpass, edge, or target correlation) is output.

The exemplary feature-based processing techniques described above provide a number of advantages over traditional image correlation pixel-based approaches. For example, the magnification and feature rotation adjustments made in the inventive match feature processing require significantly less processing than an approach which re-computes the entire input image for each adjustment iteration. Additionally, iterative resampling of the raw input image within a pixel-based approach introduces undesirable image sampling artifacts which could degrade performance. Further, the bandpass and edge features are invariant to level differences in the input images, and are much less sensitive to gain differences than a pixel-based approach. Additionally, differences in gain can be accounted for within the Intensity Score feature of the modified Hough transform. Also, the inventive feature-based approach is able to handle large spatial offsets with only a small increase in overall processing requirements. Conversely, the throughput requirements for an image correlation pixel-based approach grow exponentially as a function of the spatial search uncertainty. This limits the practical search area which can be achieved unless special purpose processing hardware is utilized. In addition, image correlation would be ineffective for sensor configurations where one sensor operated in the IR band and one sensor operated in the visible band. The inventive edge feature mode processing can identify and match on common edge features found within the image pair.

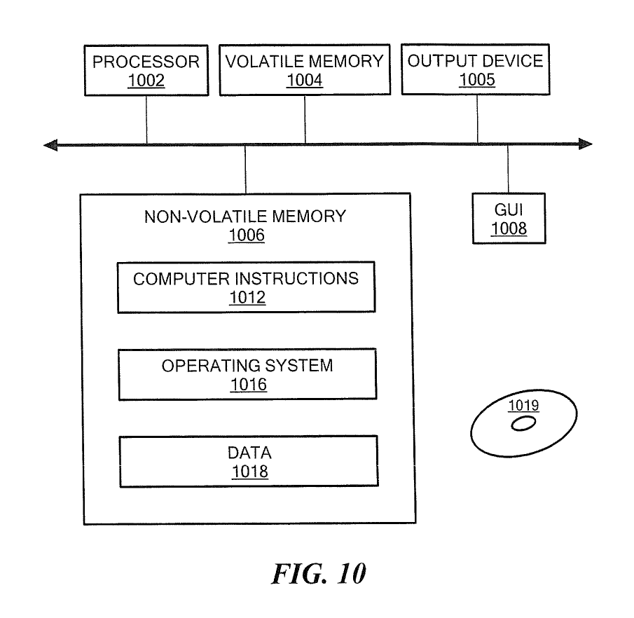

Referring to FIG. 10, a computer includes a processor 1002, a volatile memory 1004, an output device 1005, a non-volatile memory 1006 (e.g., hard disk), and a graphical user interface (GUI) 1008 (e.g., a mouse, a keyboard, a display, for example). The non-volatile memory 1006 stores computer instructions 1012, an operating system 1016 and data 1018, for example. In one example, the computer instructions 1012 are executed by the processor 1002 out of volatile memory 1004 to perform all or part of the processing described above. An article 1019 can comprise a machine-readable medium that stores executable instructions causing a machine to perform any portion of the processing described herein.

Processing is not limited to use with the hardware and software described herein and may find applicability in any computing or processing environment and with any type of machine or set of machines that is capable of running a computer program. Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Programs may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform processing.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method, comprising:
processing a first image from a first sensor having a first resolution, a first field of view, and a first spectral band;
processing a second image from a second sensor having a second resolution less than or equal to the first resolution, a second spectral band, and a second field of view overlapping with the first field of view to form a common scene, wherein the line of sight for the first and second sensors are different;
extracting features in the common scene;
matching the extracted features in the common scene; and
determining a spatial offset between the first and second sensors based upon the matched features in the common scene.

2. The method according to claim 1, further including generating a confidence value for the spatial offset.

3. The method according to claim 1, further including using bandpass processing and/or edge mode processing for the step of extracting features.

4. The method according to claim 1, wherein the step of extracting the features further includes identifying minimum and maximum peaks.

5. The method according to claim 1, wherein the step of matching further includes iterative processing over sensor magnification and roll uncertainty.

6. The method according to claim 1, wherein the step of matching further includes using a Hough Transform to generate a score surface.

7. The method according to claim 6, further including computing an intensity score within the Hough transform.

8. The method according to claim 1, wherein the step of matching further includes generating a peak list for computing a match score.

9. The method according to claim 1, further including performing target correlation for targets in the first and second images.

10. The method according to claim 1, further including cross checking of output values.

11. The method according to claim 1, further including handing off a target tracked by the first sensor to a system using the second sensor based upon the spatial offset of the first and second sensors.

12. The method according to claim 1, wherein the first and second sensors are attached to a vehicle.

13. The method according to claim 12, wherein the vehicle is an unmanned vehicle.

14. The method according to claim 1, wherein the first spectral band is selected from the group consisting of LWIR, MWIR, SWIR, and visible.

15. The method according to claim 1, wherein the first and second images are different in one or more of detector array size, gain, dynamic range, and/or thermal/contrast sensitivity.

16. An article, comprising:
a computer readable medium including non-transitory stored instructions that enable a machine to perform:
processing a first image from a first sensor having a first resolution, a first field of view, and a first spectral band;
processing a second image from a second sensor having a second resolution less than or equal to the first resolution, a second spectral band, and a second field of view overlapping with the first field of view to form a common scene, wherein the line of sight for the first and second sensors are different;
extracting features in the common scene;
matching the extracted features in the common scene; and
determining a spatial offset between the first and second sensors based upon the matched features in the common scene.

17. The article according to claim 16, further including instructions for generating a confidence value for the spatial offset.

18. A system, comprising:
a first sensor to generate a first image;
a second sensor to generate a second image, the first and second sensors having different resolutions, fields of view, and spectral bands; and
a processing means for processing the first and second images to determine a spatial offset between the first and second sensors.
